(19) United States
(12) Patent Application Publication
(10) Pub. No.: US 2020/0118233 A1
(43) Pub. Date: Apr. 16, 2020

(54) RATING AND NOTIFYING VOLUNTEER RESPONDERS

(71) Applicant: INTERNATIONAL BUSINESS MACHINES CORPORATION, Armonk, NY (US)

(72) Inventors: CHAD DELUCA, MORGAN HILL, CA (US); KEVIN D. HITE, MORGAN HILL, CA (US); RICHARD V. TRAN, SAN JOSE, CA (US)

(21) Appl. No.: 16/155,967

(22) Filed: Oct. 10, 2018

(51) Int. Cl. G06Q 50/26; G06Q 10/06; H04M 1/725; H04W 4/02; H04W 4/029; H04W 4/90

(52) U.S. Cl. CPC G06Q 50/265; G06Q 10/063112; H04M 1/72525; H04W 4/90; H04W 4/023; H04W 4/029; H04M 1/72536

(57) ABSTRACT

Examples of techniques for rating and notifying volunteer responders are disclosed. Aspects include receiving a notification of a medical emergency at a first location and obtaining a plurality of candidate volunteer responders from a volunteer responder database. Aspects also include ranking the plurality of candidate volunteer responders based on a location of each of the plurality of candidate volunteer responders, a type of the medical emergency, and a characteristic of each of the plurality of candidate volunteer responders. Aspects further include notifying a highest ranked candidate volunteer from the plurality of candidate volunteer responders of the medical emergency, wherein the notification includes the type of the medical emergency and the first location.

### BACKGROUND

The present invention generally relates to notifying volunteer responder of emergency situations, and more specifically, to ranking and notifying volunteer responders for medical emergencies.

Many people today are willing to act as a volunteer responder, or a good Samaritan, where they try to the best of their ability to help save the life of another person experiencing a medical emergency. One factor that limits the usefulness of volunteer responders is that they can only assist people when the volunteer responder knows about the medical emergency. For example, the medical emergency is within sight or hearing range. It's possible that a person in the building next door could be in distress but the volunteer responder would have no awareness that the person needs help. Another problem arises when the opposite occurs, that is when more than one volunteer responders are available to help a distressed person. In this scenario, it is hard to determine which person is more skilled and effective who should be taking the lead especially in cases where the volunteer responders do not know each other.

### SUMMARY

Embodiments of the present invention are directed to a computer-implemented method for rating and notifying volunteer responders. An example of the computer-implemented method includes receiving a notification of a medical emergency at a first location and obtaining a plurality of candidate volunteer responders from a volunteer responder database. The method also includes ranking the plurality of candidate volunteer responders based on a location of each of the plurality of candidate volunteer responders, a type of the medical emergency, and a characteristic of each of the plurality of candidate volunteer responders. The method further includes notifying a highest ranked candidate volunteer from the plurality of candidate volunteer responders of the medical emergency, wherein the notification includes the type of the medical emergency and the first location.

Embodiments of the present invention are directed to a computer program product for rating and notifying volunteer responders. The computer program product being on a computer readable storage medium having program instructions embodied therewith, the program instructions executable by a processing device to cause the processing device to perform a method. The method includes receiving a notification of a medical emergency at a first location and obtaining a plurality of candidate volunteer responders from a volunteer responder database. The method also includes ranking the plurality of candidate volunteer responders based on a location of each of the plurality of candidate volunteer responders, a type of the medical emergency, and a characteristic of each of the plurality of candidate volunteer responders. The method further includes notifying a highest ranked candidate volunteer from the plurality of candidate volunteer responders of the medical emergency, wherein the notification includes the type of the medical emergency and the first location.

Embodiments of the present invention are directed to a system for rating and notifying volunteer responders. The system includes a memory having computer readable instructions and a processing device for executing the computer readable instructions for performing a method. The method includes receiving a notification of a medical emergency at a first location and obtaining a plurality of candidate volunteer responders from a volunteer responder database. The method also includes ranking the plurality of candidate volunteer responders based on a location of each of the plurality of candidate volunteer responders, a type of the medical emergency, and a characteristic of each of the plurality of candidate volunteer responders. The method further includes notifying a highest ranked candidate volunteer from the plurality of candidate volunteer responders of the medical emergency, wherein the notification includes the type of the medical emergency and the first location.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the described techniques according to one or more embodiments described herein;

FIG. 4 depicts a block diagram of a system for rating and notifying volunteer responders according to one or more embodiments described herein;

FIG. 5 depicts a flow diagram of a method for registering volunteer responders according to one or more embodiments described herein; and

FIG. 6 depicts a flow diagram of a method for rating and notifying volunteer responders according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

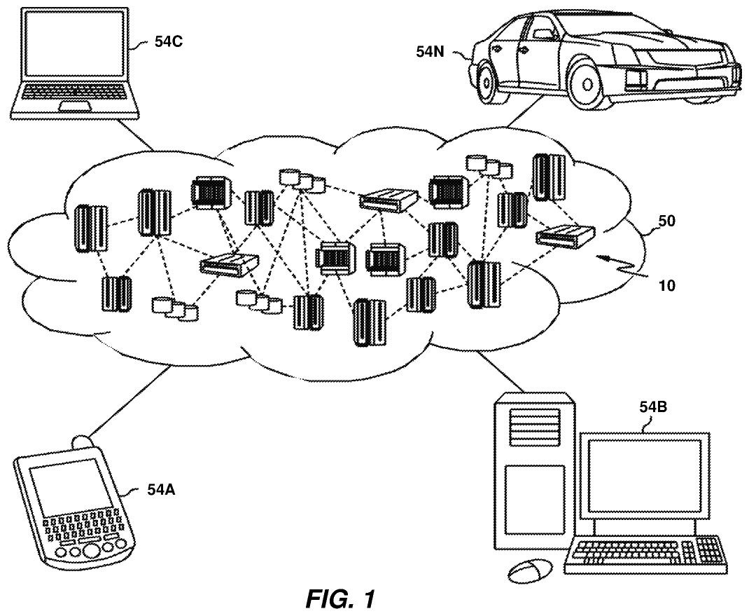

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

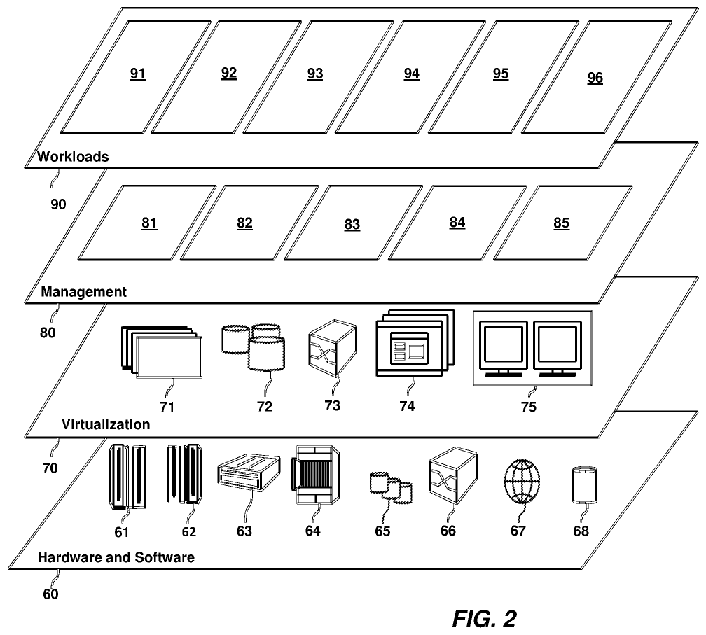

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and rating and notifying volunteer responders 96.

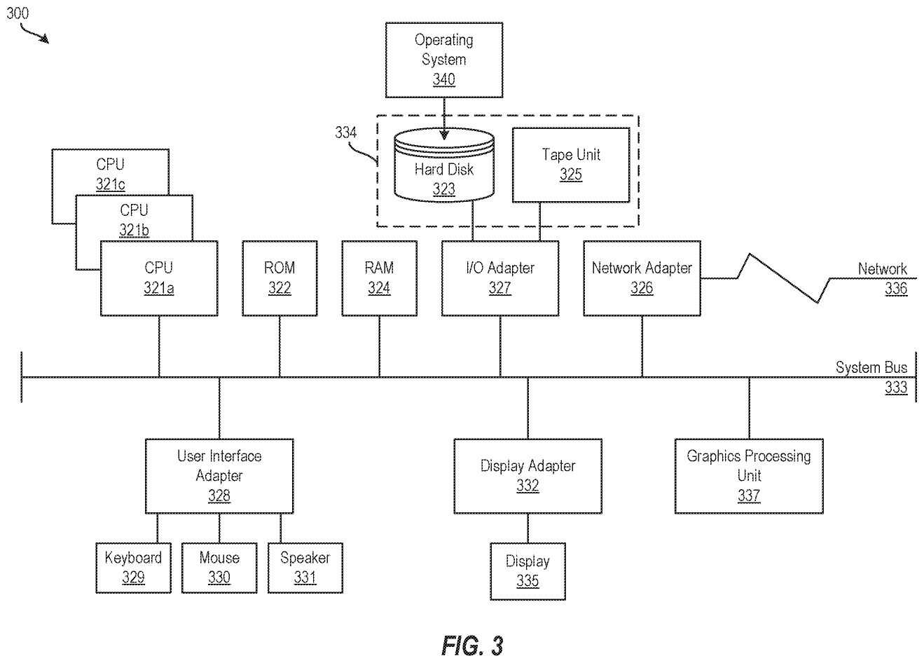

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

In exemplary embodiments, an emergency response system includes a volunteer responder database that contains information regarding registered volunteer responders that can be alerted of nearby medical emergencies that they can respond to. In exemplary embodiments, volunteer responders register with the volunteer responder database and provide information regarding their medical training, certifications, and/or experience. Once registered, the volunteer responders install a volunteer responder application on their mobile devices, such as a smartphone or smartwatch. The volunteer responder application is configured to track the location of the volunteer responder and to provide alerts of nearby medical to qualified volunteer responders.

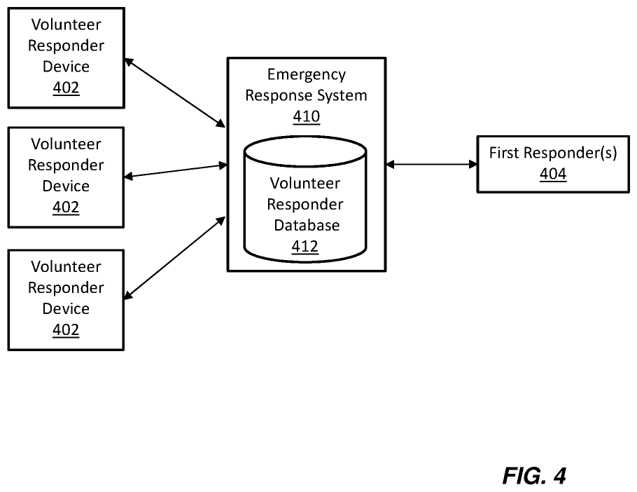

Turning now to a more detailed description of aspects of the present invention, FIG. 4 depicts a block diagram of a system 400 for rating and notifying volunteer responders according to one or more embodiments described herein. The system 400 includes an emergency response system 410 that is configured to communicate with one or more volunteer responder devices 402 and with one or more first responders 404. In exemplary embodiments, the emergency response system 410 can be embodied in a processing system such as the one shown in FIG. 3 or in a cloud-based system such as the one shown in FIGS. 1 and 2. In exemplary embodiments, the volunteer responder devices 402 can be embodied in a smartphone or smartwatch that is in communication with the emergency response system.

In exemplary embodiments, the volunteer responder devices 402 each have a volunteer responder application installed thereon and the volunteer responder application is configured to track the location of the volunteer responder device, using GPS or another suitable location determination method. In exemplary embodiments, the emergency response system 410 includes a volunteer responder database 412 that includes a profile for each of the registered volunteer responders and that includes the last known location of the volunteer responder device 402 associated with each volunteer responder.

When the emergency response system 410 receives a notification of an emergency medical situation, it is configured to alert an appropriate first responder 404, such as an EMT, police or firefighter. In addition, the emergency response system 410 is configured to access the volunteer responder database 412 and to rank the volunteer responders. Once the volunteer responders have been ranked, the emergency response system 410 is configured to provide an alert to a volunteer responder device 402 corresponding to a highest ranked volunteer responder.

In exemplary embodiment, the ranking performed by the emergency response system 410 will be based on a number of factors, that can include, but are not limited to, a current location of the volunteer responder, the skills of the volunteer responder, an expected response time of the volunteer responder, an availability of the volunteer responder, a ratings of the volunteer responder, a stress level of the volunteer responder, and a language spoken by the volunteer responder.

In exemplary embodiments, the skills of the volunteer responder are determined based on the official certifications and licenses of the volunteer responder. In one embodiment, a greater weight is applied to members of a medical profession such as a doctor, nurse or EMT. For these medical professionals, their specialties will be used for further weighting depending on the medical emergency type. A lesser weight will be given to non-medical professionals with valid First Aid, CPR and/or AED certifications. In one embodiment, non-medical professionals without any certifications or expired certifications will not be considered for dispatch but will be notified when certification training classes in the area are available.

In exemplary embodiments, the emergency response system 410 is configured to track a response time of the volunteer responders by monitoring and recording how fast a volunteer responder responds to an emergency. This data, coupled with the current location of the volunteer responder and the location of the medical emergency, is then used to determine an expected response time for each of the volunteer responder.

In exemplary embodiments, the volunteer responder application on the volunteer responder device 402 is configured to access the volunteer responder's calendar to see if they are currently involved in another event. People currently in the middle of a calendar event will be given less weight. In one embodiment, natural language processing can be used to also further determine the event and the likelihood that the volunteer responder can leave the event. For example, someone who has a calendar entry that they're on vacation may be less likely to respond to an emergency versus someone who is at the dentist.

In exemplary embodiments, medical professional ratings can be used to determine a ranking of the volunteer responder. The volunteer responder's role in the volunteer responder network is to act as a first responder until a medical professional (typically an EMT) can take over. The medical professional can rate the efficiency of communication by the first responder as the ability to provide updates and transfer information in a concise and clear manner is very important during a handoff. The medical professional can also rate the skills and quality of aid provided by the volunteer responder.

In exemplary embodiments, a stress level of a volunteer responder in responding to previous medical emergencies can be used to determine a ranking of the volunteer responder. In general, helping a person in medical distress can be a highly stressful environment. In one embodiment, a volunteer responder using wearables electronic devices, such as smartwatches, can have their stress levels observed while they are responding to a medical emergency. The observed stress levels can help determine how efficient a volunteer responder will be in responding to future medical emergencies. If it seems likely that a volunteer responder can be prone to panic attacks, then another volunteer responder can be selected.

In exemplary embodiments, a language spoken by the volunteer responder can be used to determine a ranking of the volunteer responder. In some cases, the person with the medical emergency does not speak a native language of one or more of the nearby volunteer responders. In exemplary embodiments, volunteer responders will register their language skills with the volunteer responder database and when possible an attempt will be made to match languages between the first responder and the distressed person without greatly sacrificing qualify of aid. In some embodiments, two volunteer responders may be sent where one has multiple language skills and the other has greater medical knowledge.

As discussed above, communication plays a key role in handing off information between a volunteer responder and a professional first responder. In exemplary embodiments, when a volunteer responder arrives at a scene of a medical emergency, their volunteer responder device 402 will automatically activate a microphone and/or camera on the volunteer responder device 402. The volunteer responder device 402 can then record the events happening at the scene of the medical emergency and can optionally provide updates to the emergency response system 410. In exemplary embodiments, the captured audio/video information will be saved for historical information, natural language processing can be used to pick out key bits of information that will be passed on to a responding first responder 404 in a live text stream format. This allows the first responder 404 to get a concise view of the progression of the medical emergency and be better prepared once they arrive on the scene. In cases where connectivity is bad, the text information can be saved and sent at once when a connection is re-established. Also for different languages, natural language processing can be used to attempt to do language translation.

In exemplary embodiments, available medical equipment to the volunteer responder can also factor in ranking the volunteer responders for responding to a medical emergency. The volunteer responder database 412 can include information on whether a volunteer responder typically travels with an EpiPen and dispatch those people for emergencies dealing with allergies. In another embodiment, the emergency response system 410 is aware of a location of multiple AEDs, and the emergency response system 410 can select a volunteer responder to dispatch where an AED is located along the navigation route for medical emergencies requiring one.

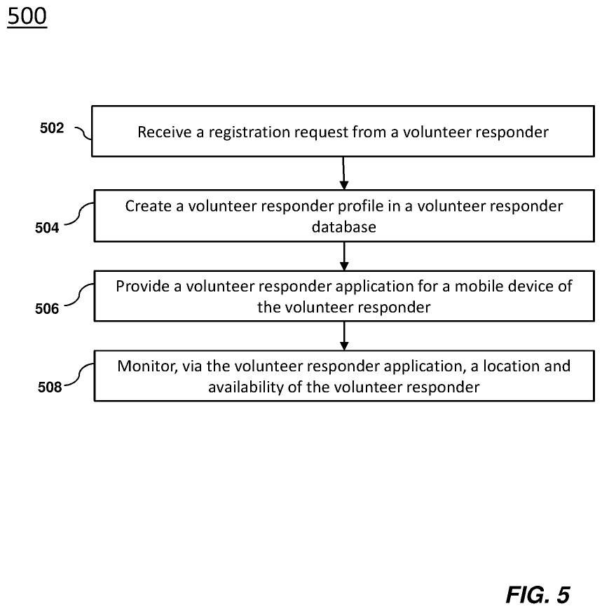

Referring now to FIG. 5, a flow diagram of a method 500 for registering volunteer responders according to one or more embodiments described herein is shown. The method 500 can be performed using any suitable processing system or device, such as the processing system 300, the emergency response system 410, and/or other suitable systems and/or devices. As shown at block 502, the method 500 includes receiving a registration request from a volunteer responder. Next, as shown at block 504, the method 500 includes creating a volunteer responder profile in a volunteer responder database. In exemplary embodiments, the volunteer responder profile includes one or more of a name of the volunteer responder, a medical training of the volunteer responder, a medical skill and/or certification of the volunteer responder; a language spoken by the volunteer responder; a medical device typically carried by the volunteer responder, and the like. Next, as shown at block 506, the method 500 includes providing a volunteer responder application for a mobile device of the volunteer responder. In exemplary embodiments, the application is installed on a smartphone or smartwatch of the volunteer responder and is used to provide the volunteer responder with notifications of emergencies that the volunteer responder can respond to. Next, as shown at block 506, the method 500 includes monitoring, via the volunteer responder application, a location and availability of the volunteer responder. In exemplary embodiments, the volunteer responder application is configured to periodically determine the location of the volunteer responder and to report that location to an emergency response system. In addition, the volunteer responder application is configured to obtain an availability of the volunteer responder and to periodically report that availability to the emergency response system. The availability of a volunteer responder can be obtained by monitoring a calendar of the volunteer responder or by monitoring a physical characteristic of the volunteer responder, i.e., is the volunteer responder awake.

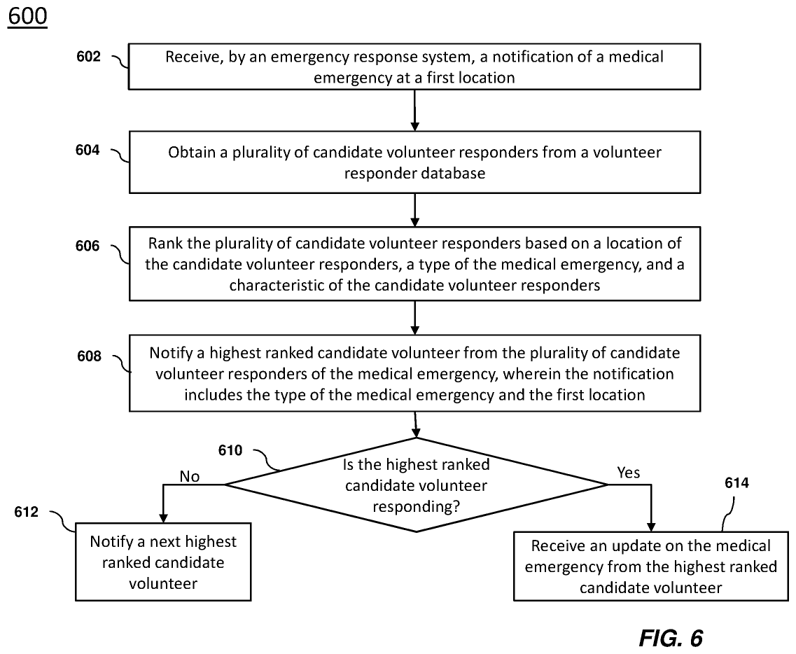

Referring now to FIG. 6, a flow diagram of a method 600 for ranking and notifying volunteer responders according to one or more embodiments described herein is shown. The method 600 can be performed using any suitable processing system or device, such as the processing system 300, the emergency response system 410, and/or other suitable systems and/or devices. As shown at block 602, the method 600 includes receiving, by an emergency response system, a notification of a medical emergency at a first location. In exemplary embodiments, the notification can be received via a call to 911 or via an electronic alert generated by an emergency alert system. In one embodiment, the notification also includes an indication of the type of medical emergency, i.e., a car wreck, a person having a heart attack, a snake bite, or the like. Next, as shown at block 604, the method 600 includes obtaining a plurality of candidate volunteer responders from a volunteer responder database. In exemplary embodiments, the plurality of candidate volunteer responders are identified based on a determination that the current location of the candidate volunteer responders is within a threshold distance from the first location. The method 600 also includes ranking the plurality of candidate volunteer responders based on a location of the candidate volunteer responders, a type of the medical emergency, and a characteristic of the candidate volunteer responders, as shown at block 606.

In one embodiment, the characteristic of each of the plurality of candidate volunteer responders includes one or more of a medical training and a professional certification. In another embodiment, the characteristic of each of the plurality of candidate volunteer responders includes one or more of an average response time of each of the plurality of candidate volunteer responders.

In exemplary embodiments, the ranking is further based upon an availability of a piece of medical equipment to each of the plurality of candidate volunteer responders. In one embodiment, the availability of the piece of medical equipment to each of the plurality of candidate volunteer responders is determined based upon identifying that the piece of medical equipment is in a possession the candidate volunteer responder. In another embodiment, the availability of the piece of medical equipment to each of the plurality of candidate volunteer responders is determined based upon identifying that the piece of medical equipment is located between the location of the candidate volunteer responder and the first location.

Continuing with reference to FIG. 6, the method 600 also includes notifying a highest ranked candidate volunteer from the plurality of candidate volunteer responders of the medical emergency, wherein the notification includes the type of the medical emergency and the first location, as shown at block 608. Next, as shown at decision block 610, the method 600 includes determining if the highest ranked candidate volunteer is responding to the medical emergency. In one embodiment, the determination that the highest ranked candidate volunteer is responding to the medical emergency can be based on the highest ranked candidate volunteer providing a response indicating that they are responding to the medical emergency. In another embodiment, the determination that the highest ranked candidate volunteer is responding to the medical emergency can be based on monitoring the movements of the highest ranked candidate volunteer. Based on determining that the highest ranked candidate volunteer is not responding to the medical emergency, the method 600 includes notifying a next highest ranked candidate volunteer, as shown at block 612. Otherwise, the method 600 proceeds to block 614 and includes receiving an update on the medical emergency from the highest ranked candidate volunteer. In exemplary embodiments, the method also includes providing the update to a dispatched first responder, such as an EMT, in route to the medical emergency. In exemplary embodiments, the update includes one or more of an audio file and a video file captured by a mobile device of the highest ranked candidate volunteer.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for rating and notifying volunteer responders, the method comprising:
receiving a notification of a medical emergency at a first location;
obtaining a plurality of candidate volunteer responders from a volunteer responder database;
ranking the plurality of candidate volunteer responders based on a location of each of the plurality of candidate volunteer responders, a type of the medical emergency, and a characteristic of each of the plurality of candidate volunteer responders; and
notifying a highest ranked candidate volunteer from the plurality of candidate volunteer responders of the medical emergency, wherein the notification includes the type of the medical emergency and the first location.

2. The method of claim 1, wherein the characteristic of each of the plurality of candidate volunteer responders includes one or more of a medical training and a professional certification.

3. The method of claim 1, wherein the characteristic of each of the plurality of candidate volunteer responders includes one or more of an average response time of each of the plurality of candidate volunteer responders.

4. The method of claim 1, wherein the ranking is further based upon a language spoken by each of the plurality of candidate volunteer responders.

5. The method of claim 1, wherein the ranking is further based upon an availability of a piece of medical equipment to each of the plurality of candidate volunteer responders.

6. The method of claim 5, wherein the availability of the piece of medical equipment to each of the plurality of candidate volunteer responders is determined based upon identifying that the piece of medical equipment is in a possession the candidate volunteer responders.

7. The method of claim 5, wherein the availability of the piece of medical equipment to each of the plurality of candidate volunteer responders is determined based upon identifying that the piece of medical equipment is located between the location of the candidate volunteer responder and the first location.

8. The method of claim 1, further comprising receiving an indication that the highest ranked candidate volunteer from the plurality of candidate volunteer responders is responding to the medical emergency.

9. The method of claim 8, further comprising:
receiving an update on the medical emergency from the highest ranked candidate volunteer; and
providing the update to a dispatched first responder in route to the medical emergency.

10. The method of claim 9, wherein the update includes one or more of an audio file and a video file captured by a mobile device of the highest ranked candidate volunteer.

11. A system for rating and notifying volunteer responders, the system comprising:
a memory comprising computer readable instructions; and
a processing device for executing the computer readable instructions for performing a method comprising:
receiving a notification of a medical emergency at a first location;
obtaining a plurality of candidate volunteer responders from a volunteer responder database;
ranking the plurality of candidate volunteer responders based on a location of each of the plurality of candidate volunteer responders, a type of the medical emergency, and a characteristic of each of the plurality of candidate volunteer responders; and
notifying a highest ranked candidate volunteer from the plurality of candidate volunteer responders of the medical emergency, wherein the notification includes the type of the medical emergency and the first location.

12. The system of claim 11, wherein the characteristic of each of the plurality of candidate volunteer responders includes one or more of a medical training and a professional certification.

13. The system of claim 11, wherein the characteristic of each of the plurality of candidate volunteer responders includes one or more of an average response time of each of the plurality of candidate volunteer responders.

14. The system of claim 11, wherein the ranking is further based upon a language spoken by each of the plurality of candidate volunteer responders.

15. The system of claim 11, wherein the ranking is further based upon an availability of a piece of medical equipment to each of the plurality of candidate volunteer responders.

16. The system of claim 15, wherein the availability of the piece of medical equipment to each of the plurality of candidate volunteer responders is determined based upon identifying that the piece of medical equipment is in a possession the candidate volunteer responders.

17. The system of claim 15, wherein the availability of the piece of medical equipment to each of the plurality of candidate volunteer responders is determined based upon identifying that the piece of medical equipment is located between the location of the candidate volunteer responder and the first location.

18. The system of claim 11, wherein the method further comprises receiving an indication that the highest ranked candidate volunteer from the plurality of candidate volunteer responders is responding to the medical emergency.

19. The system of claim 18, wherein the method further comprises:
receiving an update on the medical emergency from the highest ranked candidate volunteer; and
providing the update to a dispatched first responder in route to the medical emergency.

20. A computer program product comprising:
a computer readable storage medium having program instructions embodied therewith, the program instructions executable by a processing device to cause the processing device to perform a method for enhanced teleconferencing, the method comprising:
receiving a notification of a medical emergency at a first location;
obtaining a plurality of candidate volunteer responders from a volunteer responder database;
ranking the plurality of candidate volunteer responders based on a location of each of the plurality of candidate volunteer responders, a type of the medical emergency, and a characteristic of each of the plurality of candidate volunteer responders; and
notifying a highest ranked candidate volunteer from the plurality of candidate volunteer responders of the medical emergency, wherein the notification includes the type of the medical emergency and the first location.
